(19) United States
(12) Patent Application Publication
(10) Pub. No.: US 2026/0064205 A1
(43) Pub. Date: Mar. 5, 2026

(54) BLOCK-BASED STRUCTURE FOR HAPTIC DATA

(71) Applicant: InterDigital CE Patent Holdings, SAS, Paris (FR)

(72) Inventors: Philippe Guillotel, Vern-sur-Seiche (FR); Quentin Galvane, Thorigne-Fouillard (FR); Gurvan Lécuyer, Rennes (FR)

(21) Appl. No.: 19/105,580

(22) PCT Filed: Aug. 23, 2023
(86) PCT No.: PCT/EP2023/073172

§ 371 Date: Feb. 21, 2025

(30) Foreign Application Priority Data
Aug. 23, 2022 (EP) 22306246.4
Sep. 20, 2022 (EP) 22306376.9

(51) Int. Cl. G06F 3/01; H04N 21/235; H04N 21/435; H04N 21/845

(52) U.S. Cl. CPC G06F 3/016; H04N 21/2353; H04N 21/435; H04N 21/8455

(57) ABSTRACT

Methods, device and data stream are provided to generate, transmit and decode haptic data. The present principles generally relate to the domain of encoding haptic data. In particular, the present principles relate to a block-based structure for haptic data allowing to process chunks of data in parallel for scalable network distribution like streaming applications.

### 1. TECHNICAL FIELD

The present principles generally relate to the domain of encoding haptic data. In particular, the present principles relate to a block-based structure for haptic data allowing to process chunks of data in parallel for scalable network distribution like streaming applications.

### 2. BACKGROUND

The present section is intended to introduce the reader to various aspects of art, which may be related to various aspects of the present principles that are described and/or claimed below. This discussion is believed to be helpful in providing the reader with background information to facilitate a better understanding of the various aspects of the present principles. Accordingly, it should be understood that these statements are to be read in this light, and not as admissions of prior art.

A haptic sequence is a set of data encoded for a rendering based on the sense of touch and positioning in space like a video sequence is a set of encoded data for a rendering using the sense of vision. A haptic sequence encodes temporal data, for example represented as tracks associated with haptic devices. Haptic devices may render different modalities of the sense of touch and positioning in space like vibration, force, position, velocity or temperature. Formats mainly proprietary formats, for encoding haptic sequences exist. They are meant to be read from a local memory. However, according to recent developments of haptic devices and with on-going developments of haptic data formats, for example, the MPEG (Moving Pictures Experts Group) standardization process on the coded representation of Haptics, a format for encoding haptic data that is suitable for streaming applications and other network distribution is now needed. According to the present principles, a block-based structure for haptic data allowing to process data in parallel by chunks.

### 3. SUMMARY

The following presents a simplified summary of the present principles to provide a basic understanding of some aspects of the present principles. This summary is not an extensive overview of the present principles. It is not intended to identify key or critical elements of the present principles. The following summary merely presents some aspects of the present principles in a simplified form as a prelude to the more detailed description provided below.

The present principles relate to a method for encoding haptic data of a haptic sequence. The method comprises obtaining binary haptic data representative of haptic effects and metadata describing the haptic effects. The haptic effects are decomposed in temporal events and frequency bands and grouping them in tracks. The tracks and the metadata are encoded in access units, the metadata comprising perception data pointing to a sub-set of tracks and experience data pointing to a sub-set of perception data. In an embodiment, the access units are Network Abstraction Layer units. In another embodiment, the access units are structured depending on whether they comprise metadata or banddata. In yet another embodiment, the metadata comprise information describing a haptic effect library, avatars or devices.

The present principles also relate to a device implementing the method above. The present principles also relate to a method and a device for decoding and processing a haptic data encoded according to the method above.

### 4. BRIEF DESCRIPTION OF DRAWINGS

The present disclosure will be better understood, and other specific features and advantages will emerge upon reading the following description, the description making reference to the annexed drawings wherein:

FIG. 1 illustrates a possible organization of the data of a haptic sequence, according to the present principles;

FIG. 2 illustrates how a haptic signal can be decomposed in and/or reconstructed from two frequency bands;

FIG. 3 shows an example architecture of a processing engine 30 which may be configured to implement the present principles;

FIG. 4 illustrates a representation of a data structure compatible with the present principles;

FIG. 5 shows an example of a block-based structure for haptic data according to the present principles.

FIG. 6 describes a high level syntax for block-based structure for haptic data encoded in a data stream according to the present principles;

FIG. 7 illustrates an example of a syntax describing the NAL units of the experience type as described in relation to FIGS. 4 and 5;

FIG. 8 illustrates an example of a syntax describing the NAL units of the perception type as described in relation to FIGS. 4 and 5;

FIG. 9 shows a NAL unit structure that is proposed herein to describe the effect library, according to the present principles;

FIG. 10 proposes an example of a syntax describing a NAL unit structure to encode the metadata track as described in relation to FIGS. 4 and 5;

FIG. 11 proposes an example of a syntax describing a NAL unit structure to encode the metadata band as described in relation to FIGS. 4 and 5;

FIG. 12 shows an example of the band data structured as a NAL unit, according to the present principles.

### 5. DETAILED DESCRIPTION OF EMBODIMENTS

The present principles will be described more fully hereinafter with reference to the accompanying figures, in which examples of the present principles are shown. The present principles may, however, be embodied in many alternate forms and should not be construed as limited to the examples set forth herein. Accordingly, while the present principles are susceptible to various modifications and alternative forms, specific examples thereof are shown by way of examples in the drawings and will herein be described in detail. It should be understood, however, that there is no intent to limit the present principles to the particular forms disclosed, but on the contrary, the disclosure is to cover all modifications, equivalents, and alternatives falling within the spirit and scope of the present principles as defined by the claims.

The terminology used herein is for the purpose of describing particular examples only and is not intended to be limiting of the present principles. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to other element, there are no intervening elements present. As used herein the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the present principles.

Although some of the diagrams include arrows on communication paths to show a primary direction of communication, it is to be understood that communication may occur in the opposite direction to the depicted arrows.

Some examples are described with regard to block diagrams and operational flowcharts in which each block represents a circuit element, module, or portion of code which comprises one or more executable instructions for implementing the specified logical function(s). It should also be noted that in other implementations, the function(s) noted in the blocks may occur out of the order noted. For example, two blocks shown in succession may, in fact, be executed substantially concurrently or the blocks may sometimes be executed in the reverse order, depending on the functionality involved.

Reference herein to “in accordance with an example” or “in an example” means that a particular feature, structure, or characteristic described in connection with the example can be included in at least one implementation of the present principles. The appearances of the phrase in accordance with an example” or “in an example” in various places in the specification are not necessarily all referring to the same example, nor are separate or alternative examples necessarily mutually exclusive of other examples.

Reference numerals appearing in the claims are by way of illustration only and shall have no limiting effect on the scope of the claims. While not explicitly described, the present examples and variants may be employed in any combination or sub-combination.

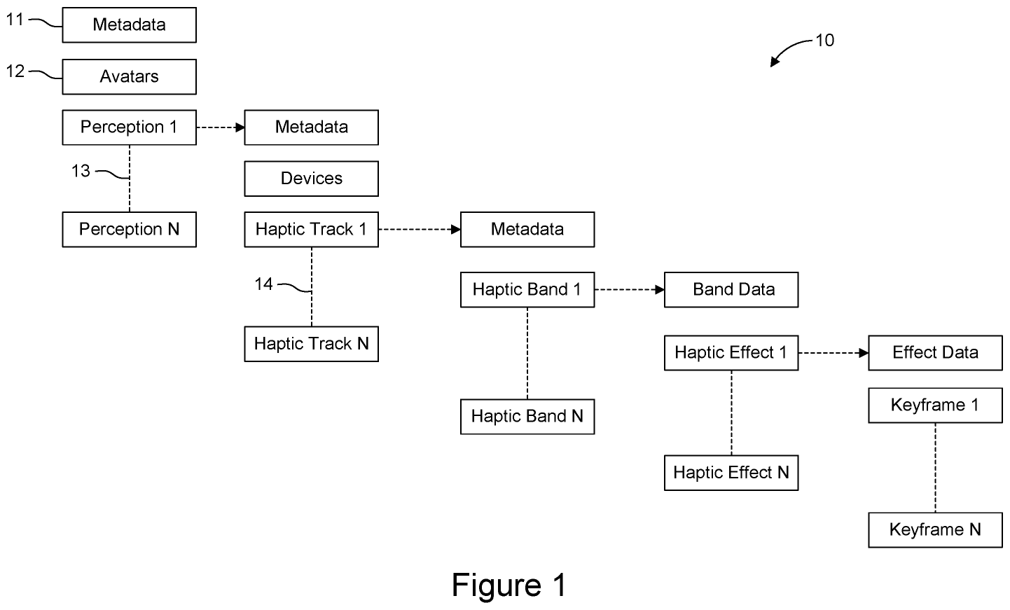

FIG. 1 illustrates a possible organization 10 of the data of a haptic sequence, according to the present principles. In the example of FIG. 1, data comprise high-level metadata information 11 describing the overall haptic experience defined in the sequence. A list of avatars 12 (i.e., body representation) is also provided. Avatars are referenced in the file to specify the desired location of haptic stimuli on the body. The haptic data are described, for example, by a list of perceptions 13. These perceptions correspond to haptic signals associated with specific perception modalities (i.e. Vibration, Force, Position, Velocity, Temperature, . . . ).

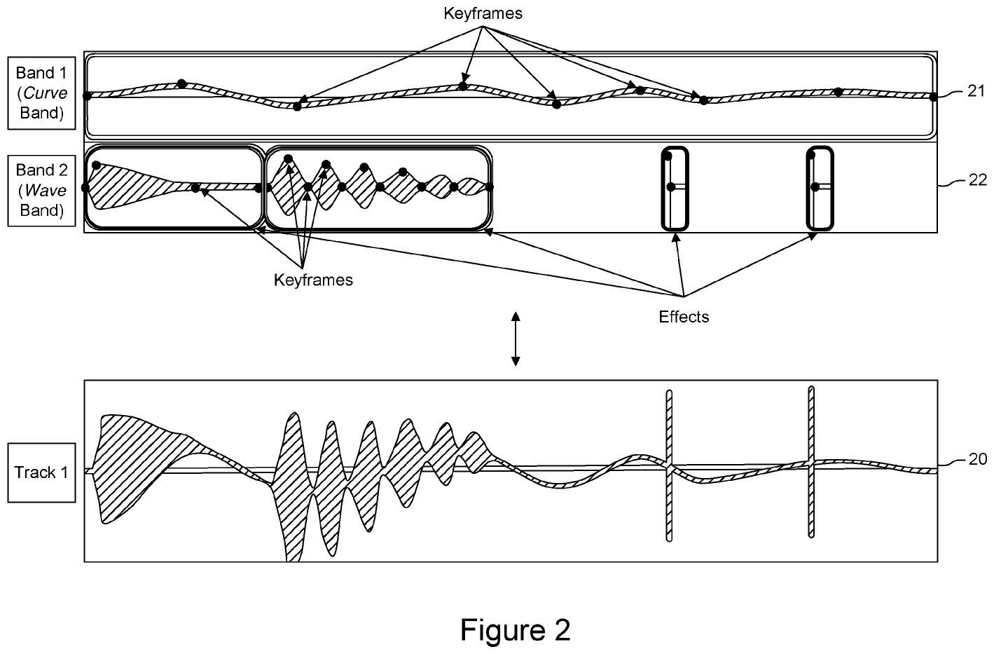

A perception comprises a list of tracks 14. In a first embodiment, a track is a signal directly usable by a haptic device associate with the track. In another embodiment, a track may be decomposed in frequency bands. Each band defines part of the signal in a given frequency range. The band may be described with a list of haptic effects each comprising a list of keyframes. The haptic signal in a track can then be reconstructed by combining the data in the bands. FIG. 2 illustrates how a haptic signal 20 can be decomposed in and/or reconstructed from two frequency bands 21 and 22. Many methods exist to decompose a signal in bands and to retrieve a signal by adding bands.

Different types of haptic bands may be considered, for example, Transient bands, Curve bands, Vectorial Wave bands and wavelet bands. A band comprises a series of “Effects” each defined by a list of “Keyframes”. The data comprised in the effects and keyframes is interpreted differently for different types of haptic bands and encoding modalities. For example:
For a transient band, each effect stores a set of keyframes defining a position, an amplitude, and a frequency. A keyframe represents a transient event.
For a curve band 21, each effect stores a set of keyframes defining a position and an amplitude. The keyframes represents the control points of the curve. The type of interpolation function (e.g. cubic or linear) used to generate the band is specified in the metadata of the band.
For a vectorial wave band, the effect stores a set of keyframes defining a position, an amplitude and a frequency.
For a wavelet wave band 22, the effect stores the contents of one wavelet block. It contains a keyframe for every coefficient of the wavelet transformed and quantized signal, with only the amplitude value used. The coefficients are scaled to a range of [−1,1]. Additionally, the original maximum amplitude is stored in a keyframe, as well as the maximum number of used bits.

A possible method for encoding haptic data of a haptic sequence takes descriptive haptics files (e.g. .IVS and .AHAP files) or waveform files (e.g. .wav files) as input. The encoding of these two types of file formats follows two distinct approaches. For descriptive input files, the encoder first analyzes the data and then transcode them, for example, to the MPEG format. For waveform signals, the data is processed using signal analysis methods to generate keyframes and either interpole between keyframes or use wavelet coding to generate a binary encoded stream. However, with such an approach, the data are stored sequentially (bands and tracks) as in a file. So, retrieving a track at a given time requires to load the entire track, access the first band and sample it, read the full first band, and then read the second band and sample it, etc. As a consequence, such encoding methods are not suitable for streaming applications and other network distribution.

According to the present principles, a method to encapsulate haptic data with a format suitable for a scalable network transmission is proposed. According to the present principles, the haptic data of a haptic sequence are prepared for a data structure that may be illustrated by Network Abstraction Layer units (NALu) packetization. In the present description, NAL units are used as an example. Other comparable data structures suitable for a scalable network transmission may be used. An Access Unit (AU) structure corresponding to the elementary stream (ES) into slices of data is proposed as another embodiment of the present principles. In this embodiment, the ES is structured into AUs (“coded samples”) which can be mapped to NALu for networking purposes (“network packets”).

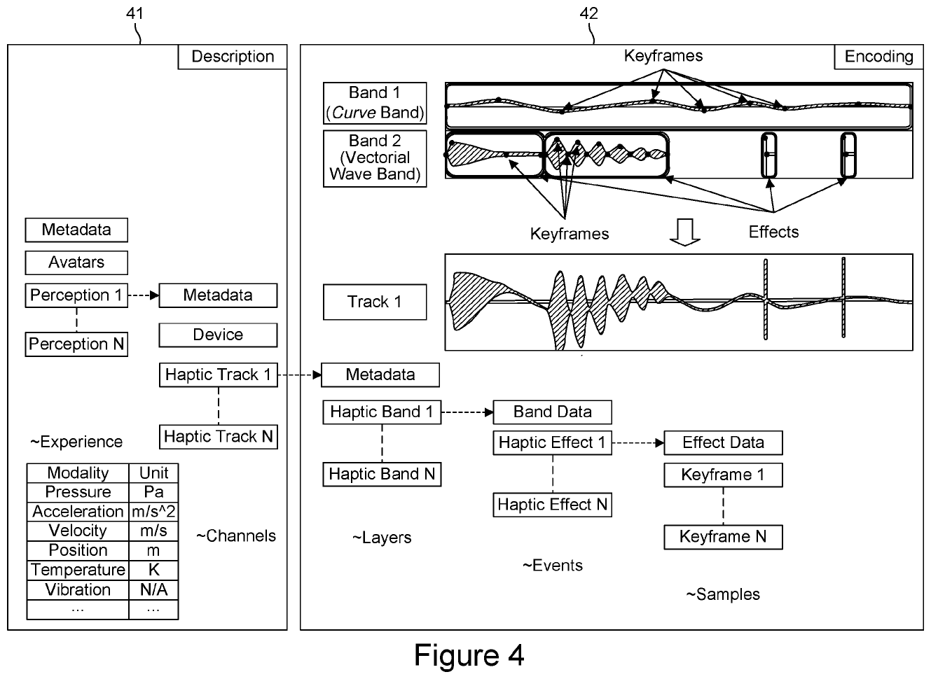

FIG. 4 illustrates a representation of a data structure compatible with the present principles. Two types of data are represented: i) description data or metadata 41 that describe how the signal is encoded (number of perception, number of tracks, body model, device . . . ), and ii) encoded binary data 42 (bands, effects and keyframes). The Network Abstraction Layer concept is adapted to haptic data according to the present principles as described below.

Following semantics tags are set up:

$$Access Units ( A U ) = Packet of decodable haptics data from the elementary stream ( E S )$$

$$NAL units ( NALu ) = Network ready packets ( packets from A U s )$$

According to the present principles, the semantics tags are based on the following properties:
Haptic Effects (FX) are sliced in Access Units (AU). The AU is the lowest, independently decodable information. It is a kind of “sample” of a track.
Haptic effects are decomposed into temporal events (Keyframes) and frequency bands, grouped into a track,
Each track is a separate channel,
A perception is a set of tracks, as a multiplex can be encoded,
An experience is a set of perceptions in different streams, comparable to multi-language audio,
AU are packetized into NALu as media-aware network elements (MANE) of different types for Network management (repeat, remove, . . . ).

On this basis, two embodiments are possible: fixed length AUs or variable length AUs.

In both cases, AUs are encapsulated into network aware packets (NALu), with the following properties:
There are two types of NAL units:
NAL units Metadata (experience, perception, track)->applies to all/several AUs
NAL units DataBand->dedicated to AUs
A NALu is composed of a NALu header+a NALu payload
NALu header should be fixed length, 1 byte typically
NALu should indicates the importance of the packet for appropriate management by the network (repetition for random access, removal for scalability . . . )

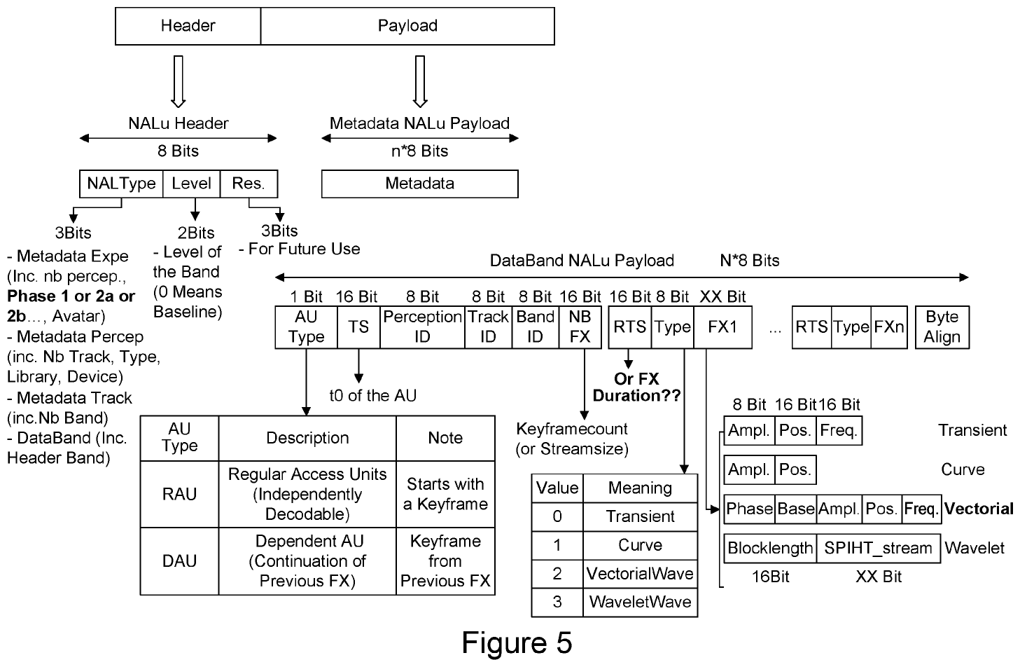

FIG. 5 shows an embodiment of a block-based structure for haptic data according to the present principles. A NALu corresponds to a header and a payload,
The NALu header is encoded with a given number of bits (for example 8 or 10 or 16), and comprises, for instance:
The NAL type: corresponding to the haptics metadata (e.g. experience, perception, Track) and the data (DataBand),
The level (e.g. encoded on 2 bits) is an added information to specify the level of the band. It specifies its importance for decoding, similarly to scalable approaches in audio and video, and
Res: a field reserved for a future use.
The NALu payload is structured depending on its type (metadata or band data):

Metadata payload comprises information describing a haptic effect library, avatars or devices. In an alternative specific NALu types may be specified for each type to simplify browsing, concerning the experience, perception and track metadata as specified in the MPEG WD.

Additional information can be added, for example:
a phase ID (e.g. 1, 2a or 2b), and/or
a profile and level of the haptics (e.g. simple, main, extended).

Band Data payload comprises:
AU type: a new flag to indicate if the AU is an independently decodable AU (RAU) or another part of a previous AU (DAU). This information is useful for random access;
TS: time stamp corresponding to the start of this AU, in reference to the global haptic experience clock;
Perception/track/Band IDs correspond to the ID of each element;
Nb FX: number of haptic effects (FX) to be encoded in this payload. In an alternative or complement, the length of the remaining payload might be encoded;
Data packets, made of several encoded effect (FX), with a relative time stamps (RTS), a type and the encoded data;
   RTS: relative time to the previous TS time stamp (=delta/increment). Allows to reduce the number of bits to encode the timing information. In an alternative, this RTS can be replaced by a global time stamps and replace the previous TS bytes,
   Type: type of the encoding method for the data according to the MPEG WD (typically transient, curve, vectorial, wavelet),
   FXi: the ith encoded effects data, according to the encoded method (type) and the current WD specification;
Byte align: stuffing bits to ensure an integer multiple of bytes for the payload.

This format is provided as an example. The number of bits may be adapted according to the implementation of the present principles. Specific codes may be added to be used for synchronization purposes. Profile and level information may be added too.

Constraints can be added for the generation of the files to make sure it is decodable:
A haptic coded stream starts by a NALu metadata experience,
The first DataBand AU is a RAU,
A RAU starts by a keyframe (e.g. wavelet),
MetaData AUs need to be repeated regularly for random access (for instance every second),
At least one Level 0 is required (and means current band is the baseline), Higher levels indicates supplemental bands that can be skipped for low bit-rates applications (kind of scalability).

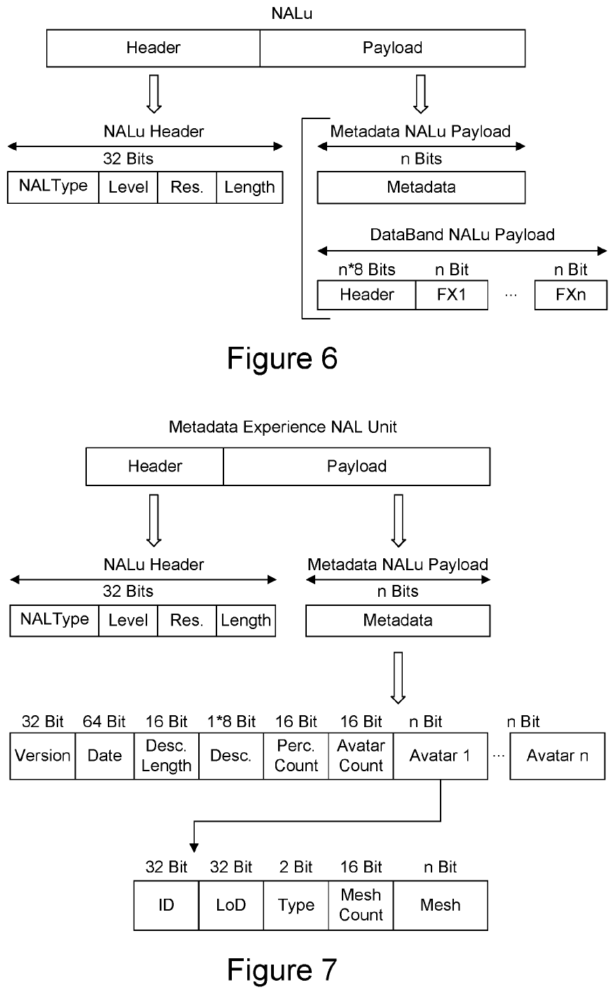

FIG. 6 to 13 shows another embodiment of a block-based structure for haptic data according to the present principles. Detail of NAL units according to the present principles is provided through these Figures. In these NAL units, some information elements are added to ease encapsulation by a network protocol. For example, byte stuffing is used to add some bits in order to have a total number of bits that is a multiple of bytes. Cyclic redundancy check (CRC) is a function computed on the transmitted bits. In case that a transmitting error occurs, the CRC computed at the receiver side is different from the transmitted CRC. Emulation bits are bits that are added when a combination of bits in the binary stream equals to a reserved number of bits (for instance “sync bits”). If it occurs, some bits are added to the bitstream in order to prevent this error.

FIG. 6 describes a high-level syntax for block-based structure for haptic data encoded in a data stream according to the present principles. In this embodiment, the NAL unit starts with a header part comprising, for example, the type of the NAL unit and the length of the payload (e.g. in bytes). Adding the length of the payload in the header of the NAL unit is useful for network applications. When receiving a NAL unit, an application first read the header and get the number of bits that is required to be read for the payload. So, this memory size can be used to process parallel reading and/or to detect bits loss (as a check sum). According to the present principles, the payload comprises a metadata part and a data band part.

FIG. 7 illustrates an example of a syntax describing the NAL units of the experience type as described in relation to FIGS. 4 and 5. As any NAL unit, an experience NAL unit comprises a header and a payload. Avatars are described in these NAL units.

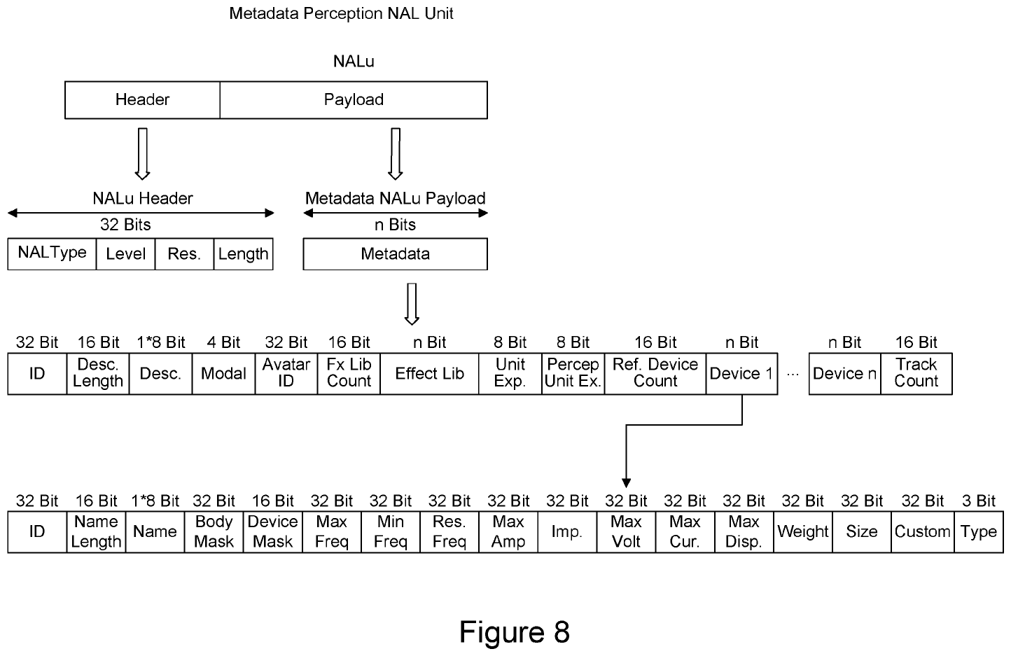

FIG. 8 illustrates an example of a syntax describing the NAL units of the perception type as described in relation to FIGS. 4 and 5. As any NAL unit, an experience NAL unit comprises a header and a payload. In the example of FIG. 8, the Metadata NAL unit payload comprises a library of the effect. In a variant, the effect library is stored in the payload of a band data.

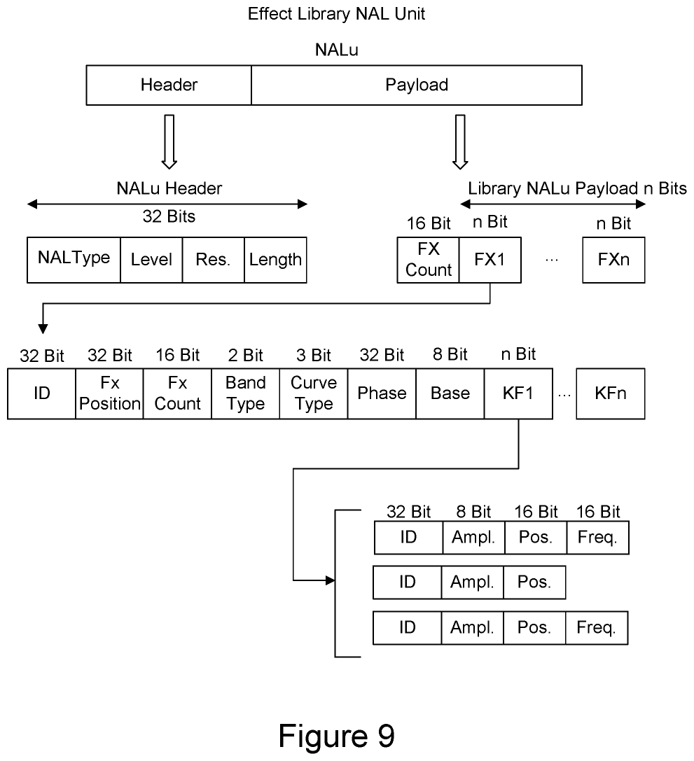

FIG. 9 shows a NAL unit structure that is proposed herein to describe the effect library. Instead of being included into the payload of a band data, the effect library is separated as a dedicated NAL unit. Thus, the effect library can be sent separately from the payload and thus ease parallelization process and increase error robustness. In addition, such a separated structure allows to change the effects during an experience (similar to an update of the library), and to ease usage by editing tools or servers. For example, a generic NAL unit may be stored per artist or application, and just needs to be indexed when an effect is used. The way the effect library is built when separated from the payload is different. Some syntax elements that are available in the stream are repeated here (inside the effect library NAL unit), for example the Curve type or the band type in order to ensure that the effect library NAL unit is independent from the current experience.

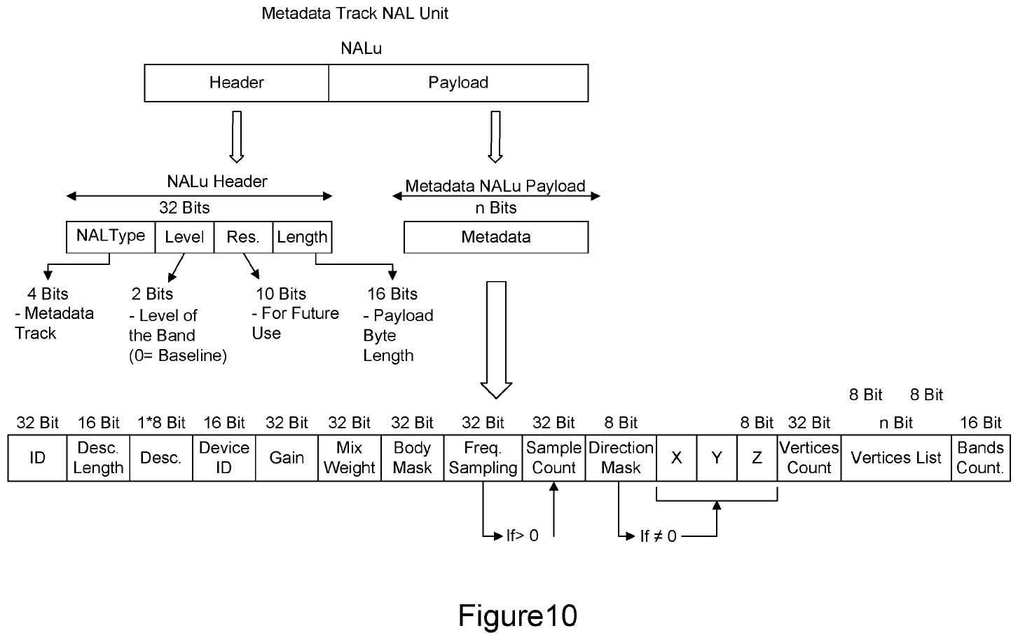

FIG. 10 proposes an example of a syntax describing a NAL unit structure to encode the metadata track as described in relation to FIGS. 4 and 5. As any NAL unit, an experience NAL unit comprises a header and a payload.

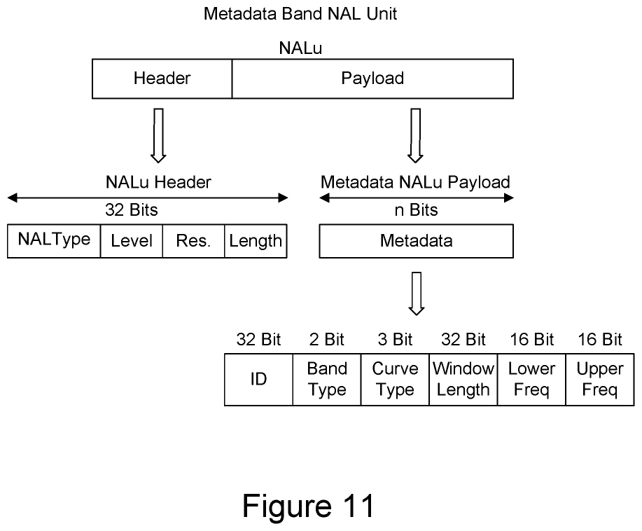

FIG. 11 proposes an example of a syntax describing a NAL unit structure to encode the metadata band as described in relation to FIGS. 4 and 5. As any NAL unit, an experience NAL unit comprises a header and a payload. Instead of being included into the payload of a band data, it is separated as a dedicated NAL unit. Thus, the metadata band can be sent separately from the payload and thus ease parallelization or and increase error robustness.

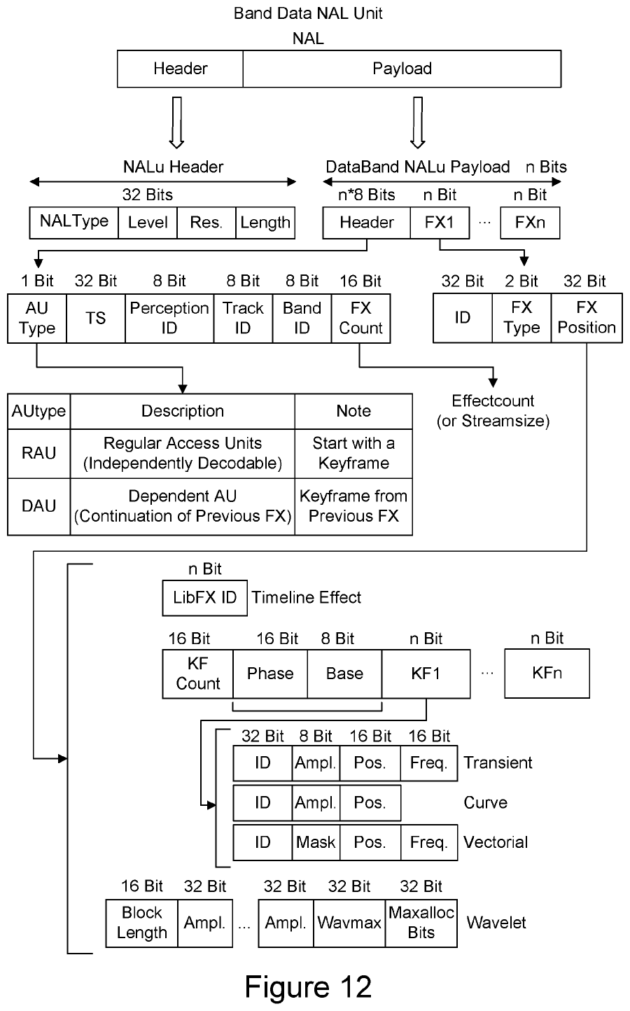

FIG. 12 shows an example of the band data structured as a NAL unit.

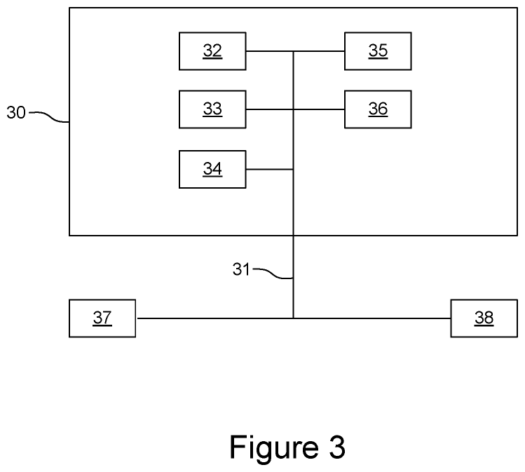

FIG. 3 shows an example architecture of a processing engine 30 which may be configured to implement the present principles. This device may be linked with other devices via their bus 31 and/or via I/O interface 36.

Device 30 comprises following elements that are linked together by a data and address bus 31:
a microprocessor 32 (or CPU), which is, for example, a DSP (or Digital Signal Processor);
a ROM (or Read Only Memory) 33;
a RAM (or Random Access Memory) 34;
a storage interface 35;
an I/O interface 36 for reception of data to transmit, from an application; and
a power supply (not represented in FIG. 2), e.g. a battery.

In accordance with an example, the power supply is external to the device. In each of mentioned memory, the word «register» used in the specification may correspond to area of small capacity (some bits) or to very large area (e.g. a whole program or large amount of received or decoded data). The ROM 33 comprises at least a program and parameters. The ROM 33 may store algorithms and instructions to perform techniques in accordance with present principles. When switched on, the CPU 32 uploads the program in the RAM and executes the corresponding instructions.

The RAM 34 comprises, in a register, the program executed by the CPU 32 and uploaded after switch-on of the device 30, input data in a register, intermediate data in different states of the method in a register, and other variables used for the execution of the method in a register.

The implementations described herein may be implemented in, for example, a method or a process, an apparatus, a computer program product, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Device 30 is linked, for example via bus 31 to a set of sensors 37 and to a set of rendering devices 38. Sensors 37 may be, for example, cameras, microphones, temperature sensors, Inertial Measurement Units, GPS, hygrometry sensors, IR or UV light sensors or wind sensors. Rendering devices 38 may be, for example, displays, speakers, vibrators, heat, fan, etc.

In accordance with examples, the device 30 is configured to implement a method according to the present principles, and belongs to a set comprising:
a mobile device;
a communication device;
a game device;
a tablet (or tablet computer);
a laptop;
a still picture camera;
a video camera.

The implementations described herein may be implemented in, for example, a method or a process, an apparatus, a computer program product, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, Smartphones, tablets, computers, mobile phones, portable/personal digital assistants (“PDAs”), and other devices that facilitate communication of information between end-users.

Implementations of the various processes and features described herein may be embodied in a variety of different equipment or applications, particularly, for example, equipment or applications associated with data encoding, data decoding, view generation, texture processing, and other processing of images and related texture information and/or depth information. Examples of such equipment include an encoder, a decoder, a post-processor processing output from a decoder, a pre-processor providing input to an encoder, a video coder, a video decoder, a video codec, a web server, a set-top box, a laptop, a personal computer, a cell phone, a PDA, and other communication devices. As should be clear, the equipment may be mobile and even installed in a mobile vehicle.

Additionally, the methods may be implemented by instructions being performed by a processor, and such instructions (and/or data values produced by an implementation) may be stored on a processor-readable medium such as, for example, an integrated circuit, a software carrier or other storage device such as, for example, a hard disk, a compact diskette (“CD”), an optical disc (such as, for example, a DVD, often referred to as a digital versatile disc or a digital video disc), a random access memory (“RAM”), or a read-only memory (“ROM”). The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data the rules for writing or reading the syntax of a described embodiment, or to carry as data the actual syntax-values written by a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application.

1. A method for encoding haptic data of a haptic sequence, the method comprising:
obtaining binary haptic data representative of haptic effects and metadata describing the haptic effects;
decomposing the haptic effects in temporal events and frequency bands and grouping them in tracks; and
encoding the tracks and the metadata in access units, the metadata comprising perception data pointing to a sub-set of tracks and experience data pointing to a sub-set of perception data.

2. The method of claim 1, wherein the access units are Network Abstraction Layer units.

3. The method of claim 1, wherein the access units are structured depending on whether they comprise metadata or band data.

4. The method of claim 1, wherein the metadata comprises information describing a haptic effect library, avatars or devices.

5. A device for encoding haptic data of a haptic sequence, the device comprising a processor configured for:
obtaining binary haptic data representative of haptic effects and metadata describing the haptic effects;
decomposing the haptic effects in temporal events and frequency bands and grouping them in tracks; and
encoding the tracks and the metadata in access units, the metadata comprising perception data pointing to a sub-set of tracks and experience data pointing to a sub-set of perception data.

6. The device of claim 5, wherein the access units are Network Abstraction Layer units.

7. The device of claim 5, wherein the access units are structured depending on whether they comprise metadata or band data.

8. The device of claim 5, wherein the metadata comprises information describing a haptic effect library, avatars or devices.

9. A method for decoding haptic data of a haptic sequence, the method comprising:
obtaining a set of tracks and metadata encoded in access units, the metadata comprising perception data pointing to a sub-set of tracks and experience data pointing to a sub-set of perception data; and
accessing the experience data in tracks pointed by perception data associated with the experience data.

10. The method of claim 9, wherein the access units are Network Abstraction Layer units.

11. The method of claim 9, wherein the access units are structured depending on whether they comprise metadata or band data.

12. The method of claim 9, wherein the metadata comprises information describing a haptic effect library, avatars or devices.

13. A device for decoding haptic data of a haptic sequence, the device comprising a processor configured for:
obtaining a set of tracks and metadata encoded in access units, the metadata comprising perception data pointing to a sub-set of tracks and experience data pointing to a sub-set of perception data; and
accessing the experience data in tracks pointed by perception data associated with the experience data.

14. The device of claim 13, wherein the access units are Network Abstraction Layer units.

15. The device of claim 13, wherein the access units are structured depending on whether they comprise metadata or band data.

16. The device of claim 13, wherein the metadata comprises information describing a haptic effect library, avatars or devices.
